(19) United States
(12) Patent Application Publication
(10) Pub. No.: US 2021/0206635 A1
(43) Pub. Date: Jul. 8, 2021

(54) STABILIZED HYDROGEN PEROXIDE-CHLORATE MIXTURES

(71) Applicant: Evonik Corporation, Parsippany, NJ (US)

(72) Inventor: Gregory Melenkevitz, Union, NJ (US)

(73) Assignee: Evonik Corporation, Parsippany, NJ (US)

(21) Appl. No.: 17/058,761

(22) PCT Filed: Aug. 1, 2019
(86) PCT No.: PCT/US2019/044650

§ 371 Date: Nov. 25, 2020

Related U.S. Application Data
(60) Provisional application No. 62/713,753, filed on Aug. 2, 2018.

(51) Int. Cl. C01B 11/02; C01B 15/037

(52) U.S. Cl. CPC C01B 11/026; C01B 15/037

(57) ABSTRACT

Aqueous solutions of hydrogen peroxide and alkali metal chlorate are stabilized by a polymeric stabilizer selected from phosphino polycarboxylic acid, poly(acrylic acid), a poly(acrylic acid)-acrylamidoalkylpropane sulfonic acid co-polymer and a poly(acrylic acid)-acrylamidoalkylpropane sulfonic acid-sulfonated styrene terpolymer.

### CROSS-REFERENCE TO RELATED APPLICATIONS

This application is a 35 U.S.C. § 371 U.S. national phase entry of International Application No. PCT/US2019/044650 having an international filing date of Aug. 1, 2019, which claims the benefit of U.S. Provisional Application No. 62/713,753 filed Aug. 2, 2018, both of which are incorporated herein by reference in its entirety.

### FIELD

The present invention relates to a composition containing alkali metal chlorate, hydrogen peroxide and one or more polymeric stabilizers, and a process for producing chlorine dioxide using said composition as a feed.

### BACKGROUND

Chlorine dioxide is primarily used in pulp bleaching, but there is a growing interest of using it also in other applications such as water purification, waste water treatment, fat bleaching, removal of organic materials from industrial wastes, various biological control applications (cooling towers, oil field), or disinfection of food (vegetables). Since chlorine dioxide is not storage stable it must be produced on-site.

Production of chlorine dioxide in large scale is usually performed by reacting alkali metal chlorate or chloric acid with a reducing agent and recovering chlorine dioxide gas. Such processes are described in, for example, U.S. Pat. Nos. 5,091,166, 5,091,167 and 5,366,714, and EP patent 612886.

Production of chlorine dioxide in small scale, such as for water purification applications, can also be done from alkali metal chlorate and a reducing agent but requires somewhat different processes, such as those described in U.S. Pat. Nos. 5,376,350 and 5,895,638.

The above small scale processes include feeding alkali metal chlorate, hydrogen peroxide and a mineral acid to a reactor, in which chlorate ions are reduced to form chlorine dioxide. In these processes it has now been found favorable to use a premixed solution of alkali metal chlorate and hydrogen peroxide as a feed. However, such solutions are not storage stable, particularly due to decomposition of hydrogen peroxide, but there is also a risk for a reaction between the hydrogen peroxide and the chlorate to form chlorine dioxide. The decomposition of hydrogen peroxide is particularly rapid in the presence of ferrous and/or chromium ions, which may be introduced as in impurity in alkali metal chlorate or be released from storage containers of steel.

There is a need for storage stable solutions of hydrogen peroxide and chlorate for the generation of chlorine dioxide.

### SUMMARY

The invention provides improved stability of hydrogen peroxide-chlorate mixtures that have use in the generation of chlorine dioxide for various biological control applications including in cooling towers and oil fields, disinfection of food (e.g., vegetables), wastewater treatment, and potable water treatment. The polymeric stabilizer disclosed herein provides improved shelf-life stability, which permits more consistent chlorine dioxide production as the ratio of peroxide to chlorate should remain at the required level.

In one aspect, the present invention provides a storage stable aqueous mixture of alkali metal chlorate and hydrogen peroxide that can be safely transported comprising:

hydrogen peroxide;
an alkali metal chlorate; and
one or more polymeric stabilizers selected from
a) a phosphino polycarboxylic acid, or salt thereof, the phosphino polycarboxylic acid having a molecular weight of 1500 to 10,000 g/mol;
b) a poly(acrylic acid), or a salt thereof, with molecular weight of 4000-5000 g/mol; and
c) a polymer, or salt thereof, with molecular weight of 3000 to 15,000 g/mol, the polymer being derived from a plurality of monomer units of each of

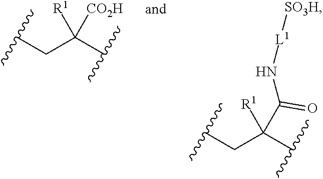

and optionally

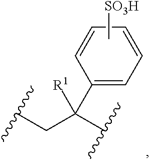

wherein R¹ is hydrogen or C₁₋₄alkyl and L¹ is C₂₋₆alkylene.

In another aspect is provided a process for producing chlorine dioxide, particularly in small scale, using such a mixture as a feed.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

For the recitation of numeric ranges herein, each intervening number there between with the same degree of precision is explicitly contemplated. For example, for the range 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9 and 7.0 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Concentrations and fractions given in “%” and “ppm” refer to weight unless specified otherwise.

In some embodiments, the one or more polymeric stabilizers is selected from a phosphino polycarboxylic acid, or salt thereof. In some embodiments, the phosphino polycarboxylic acid has formula (I)

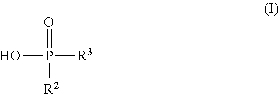

wherein R² is

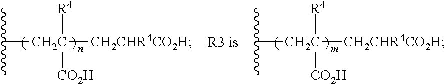

R4, at each occurrence, is independently hydrogen or C₁₋₄ alkyl; and m and n are each independently an integer, where m+n is an integer from 30 to 60. In some embodiments, R⁴ is hydrogen. In some embodiments, the phosphino polycarboxylic acid has a molecular weight of 3300-3900 g/mol.

In some embodiments, the one or more polymeric stabilizers is selected from a poly(acrylic acid), or a salt thereof. In some embodiments, the poly(acrylic acid), or salt thereof, has a molecular weight of 4100-4900 g/mol.

In some embodiments, the one or more polymeric stabilizers is selected from a polymer, or salt thereof, with molecular weight of 3000 to 15,000 g/mol, the polymer being derived from a plurality of monomer units of each of

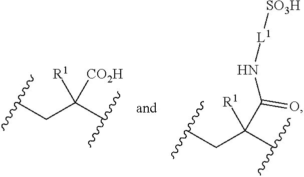

wherein R¹ is hydrogen or C₁₋₄alkyl and L¹ is C₂₋₆alkylene. In some embodiments, the polymer is derived from a plurality of monomer units of each of

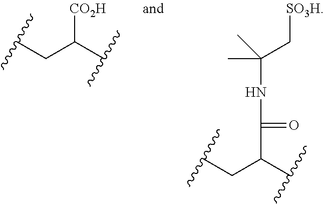

The polymeric stabilizers preferably consist of the specified monomer units.

In some embodiments, the one or more polymeric stabilizers is selected from a polymer, or salt thereof, with molecular weight of 3000 to 15,000 g/mol, the polymer being derived from a plurality of monomer units of each of

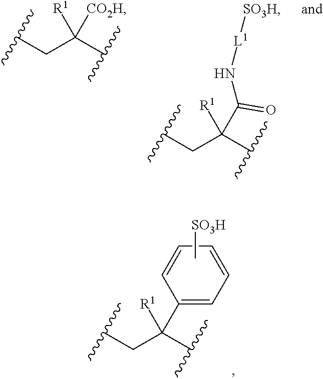

wherein R¹ is hydrogen or C₁₋₄alkyl and L¹ is C₂₋₆alkylene. In some embodiments, the polymer is derived from a plurality of monomer units of each of

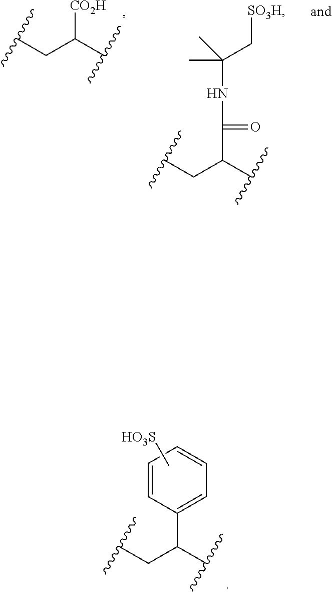

The polymeric stabilizers preferably consist of the specified monomer units.

In some embodiments, the salt of a polymeric stabilizer is an alkali metal salt. In some embodiments, the alkali metal salt is a sodium salt.

The term “alkyl” as used herein, means a straight or branched chain saturated hydrocarbon. Representative examples of alkyl include, but are not limited to, methyl, ethyl, npropyl, isopropyl, n-butyl, sec-butyl, isobutyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkylene,” as used herein, means a divalent group derived from a straight or branched chain saturated hydrocarbon. Representative examples of alkylene include, but are not limited to, —CH₂—, —CH₂CH₂—, —CH₂CH₂CH₂—, —CH₂CH(CH₃)CH₂—, and CH₂CH(CH₃)CH(CH₃)CH₂—.

Terms such as “alkyl” and “alkylene,” may be preceded by a designation indicating the number of atoms present in the group in a particular instance (e.g., “C₁₋₄alkyl,” “C₁₋₄alkylene”). These designations are used as generally understood by those skilled in the art. For example, the representation “C” followed by a subscripted number indicates the number of carbon atoms present in the group that follows. Thus, “C₃alkyl” is an alkyl group with three carbon atoms (i.e., n-propyl, isopropyl). Where a range is given, as in “C₁₋₄,” the members of the group that follows may have any number of carbon atoms falling within the recited range. A “C₁₋₄alkyl,” for example, is an alkyl group having from 1 to 4 carbon atoms, however arranged (i.e., straight chain or branched).

In some embodiments, the hydrogen peroxide-chlorate solution is stabilized with at least 0.1-1500 ppm of the one or more polymeric stabilizers. In some embodiments, the hydrogen peroxide-chlorate solution is stabilized with from 0.1-60 ppm, 0.1-50 ppm, 0.1-40 ppm, 0.1-30 ppm, 0.1-20 ppm, 0.1-10 ppm, 10-20 ppm, 20-30 ppm, 30-40 ppm, 40-50 ppm, or 50-60 ppm of the one or more polymeric stabilizers. In other embodiments, the hydrogen peroxide-chlorate solution is stabilized with higher concentrations of the one or more polymeric stabilizers. For example, the hydrogen peroxide-chlorate solution may be stabilized with from 50-150 ppm, 150-250 ppm, 250-350 ppm, 350-650 ppm, 600-900 ppm, 800-1200 ppm, or 1200-1600 ppm of the one or more polymeric stabilizers. In some embodiments, the one or more polymeric stabilizers are added in an amount ≥100 ppm, ≥200 ppm, ≥300 ppm, ≥500 ppm, ≥750 ppm, ≥1000 ppm, ≥1500 ppm, or ≥2000 ppm.

In some embodiments, the composition of the invention comprises an aqueous solution comprising from about 1 to about 6.5 mol/l, preferably from about 3 to about 6 mol/l of alkali metal chlorate, from about 1 to about 7 mol/l (about 5-22 weight %) hydrogen peroxide, preferably from about 3 to about 5 mol/l (about 10-16 weight %) of hydrogen peroxide and one or more polymeric stabilizers, as described herein.

In some embodiments, the pH of the aqueous solution is from about 1 to about 4, preferably from about 1.5 to about 3.5, most preferably from about 2 to about 3.

The use of the polymer stabilizer system herein does not preclude or restrict the presence of other known stabilizers. Stabilized solutions of the invention may include additional stabilizers or additives, such as a phosphate, a stannate, a chelant, or a radical scavenger. Stabilizers may also be chosen from nitric acid, phosphoric acid, benzoic acid, dipicolinic acid (DPA), from salts chosen from nitrate, phosphate, pyrophosphate, stannate, benzoate, salicylate, diethylene triamine penta (methylene phosphonate), and mixtures thereof. The salts may be ammonium or alkaline metal salts, especially ammonium or sodium salts. The stabilizer may be chosen from nitric acid, phosphoric acid, di-sodium pyrophosphate, ammonium nitrate, sodium nitrate, sodium stannate, and mixtures thereof. The stabilizer may be added in amount of from 0.1 to 200 ppm, 0.1 to 100 ppm, 0.1 to 50 ppm, 0.1 to 40 ppm, 0.1 to 30 ppm, 0.1 to 20 ppm, 0.1 to 10 ppm, 0.1 to 5 ppm. Those amounts are those based on the weight of the solution.

A phosphate salt can take the form of the simple monomeric species, or of the condensed linear polyphosphate, or cyclic polyphosphate(metaphosphate). The monomeric phosphate salts are of the general formula, MₙH_{q}PO₄, (in which q=0, 1, or 2; n=1, 2, or 3; n+q=3). Here M can be one or more monovalent cations selected from the following: Li, Na, K, NH₄, NR₄ (where R represents an alkyl chain containing 1 to 5 C atoms). The polyphosphates have the general formula, Mₙ₊₂PₙO₃ₙ₊₁ where n=2 to 8, and M can be chosen from Li, Na, K, NH₄, NR₄ where R represents an alkyl chain containing 1 to 5 C atoms). The cyclic polyphosphates have the general formula MₙPₙO₃ₙ where n=3 to 8 and M can be chosen from Li, Na, K, NH₄, NR₄ where R represents a linear or branched alkyl group containing 1 to 5 C atoms). The above may be optionally introduced into the stabilizer system in their acid form. Exemplary phosphates include pyrophosphoric acid and metaphosphoric acid and their salts, e.g., sodium salts.

Compositions of the invention may further include a phosphonic acid based chelant, for example, in an amount from about 0.1 to about 5 mmol/l, or from about 0.5 to about 3 mmol/l. In some embodiments, a protective colloid may be present, for example, from about 0.001 to about 0.5 mol/l, or from about 0.02 to about 0.05 mol/l. If a radical scavenger is present, its concentration may be from about 0.01 to about 1 mol/l, or from about 0.02 to about 0.2 mol/l.

The water content in the composition is suitably from about 20 to about 70 wt %, preferably from about 30 to about 60 wt %, most preferably from about 40 to about 55 wt %. The invention also relates to a preferably-continuous process for producing chlorine dioxide comprising the steps of:

(a) feeding an aqueous solution comprising alkali metal chlorate, hydrogen peroxide and one or more polymeric stabilizers and a mineral acid, or a mixture thereof, to a reactor to form an aqueous reaction mixture;
(b) reacting chlorate ions with hydrogen peroxide in said reaction mixture to form chlorine dioxide; and
(c) recovering a product containing chlorine dioxide.

As high pH favors decomposition of hydrogen peroxide, while low pH favors formation of chlorine dioxide, both can be avoided by selecting the above pH range. The pH is affected, inter alia, by the amount of hydrogen peroxide and by the polymeric stabilizer, protective colloid, radical scavenger or chelant used. If necessary, the pH of the aqueous solution can be adjusted to a suitable level by adding small amounts of any acid or alkaline substance compatible with hydrogen peroxide and chlorate, such as Na₄P₂O₇ or H₃PO₄.

Any phosphonic acid based chelant can be used, such as amino trimethylene phosphonic acid (ATMP), 2-phosphonobutane-1,2,4-tricarboxylic acid (PBTCA), N-sulfonic amino dimethylene phosphonic acid (SADP), methylamine dimethylene phosphonic acid (MADMP), glycine dimethyl phosphonic acid (GDMP), 2-hydroxyphosphonocarboxylic acid (HPAA), polyhydric alcohol phosphate ester (PAPE) 1-hydroxyethylidene-1, 1-diphosphonic acid (HEDP), 1-aminoethane-1, 1-diphosphonic acid, amino trimethylenephosphonic acid (ATMP), ethylene diamine tetra(methylenephosphonic acid), hexamethylene diamine tetra (methylenephosphonic acid), diethylenetriamine penta (methylenephosphonic acid) (DTPMP), diethylenetriamine hexa(methylenephosphonic acid), and 1-aminoalkane-1,1-diphosphonic acids such as morpholinomethane diphosphonic acid, N,N-dimethyl aminodimethyl diphosphonic acid, aminomethyl diphosphonic acid, or salts thereof, preferably sodium salts.

Useful protective colloids include tin compounds, such as alkali metal stannate, particularly sodium stannate (Na₂(Sn(OH)₆). Stannates further include stannic chloride, stannic oxide, stannic bromide, stannic chromate, stannic iodide, stannic sulfide, tin dichloride bis(2,4-pentanedionate), tin phthalocyanine dichloride, tin acetate, tin t-butoxide, di-n-butyl tin(IV) dichloride, tin methacrylate, tin fluoride, tin bromide, stannic phosphide, stannous chloride, stannous fluoride, stannous pyrophosphate, sodium stannate, stannous 2-ethylhexoate, stannous bromide, stannous chromate, stannous fluoride, stannous methanesulfonate, stannous oxalate, stannous oxide, stannous sulfate, stannous sulfide, barium stannate, calcium stannate, copper(II) stannate, lead stannate dihydrate, zinc stannate, sodium stannate, potassium stannate trihydrate, strontium stannate, cobalt(II) stannate dihydrate, sodium trifluorostannate, ammonium hexachlorostannate, and lithium hexafluorostannate.

Useful radical scavengers include pyridine carboxylic acids, such as 2,6-pyridine dicarboxylic acid. It is to be understood that the composition of the invention can include mixtures of two or more of at least one protective colloid at least one radical scavenger and at least one phosphonic acid based chelant.

In some embodiments, the aqueous hydrogen peroxide-chlorate solution is free, or substantially free, of stannate. In some embodiments, the hydrogen peroxide-chlorate solution is free of, or substantially free of, stannate and/or phosphate.

In some embodiments, the aqueous hydrogen peroxide-chlorate solution is free of, or substantially free of, a chelating substance other than the one or more polymeric stabilizers.

In some embodiments, the aqueous hydrogen peroxide solution consists essentially of hydrogen peroxide, an alkali metal chlorate, water, and the polymeric stabilizer, as described herein. In other embodiments, the aqueous hydrogen peroxide solution consists essentially of hydrogen peroxide, an alkali metal chlorate, water, a phosphate, and the polymeric stabilizer, as described herein.

In the aqueous solution of the new composition the molar ratio H₂O₂ to ClO₃ suitably is from about 0.2:1 to about 2:1, preferably from about 0.5:1 to about 1.5:1, most preferably from about from about 0.5:1 to about 1:1. Using a composition of this ratio for producing chlorine dioxide has been found to give high conversion of the chlorate.

In order to inhibit corrosion, the composition may contain a nitrate salt, preferably alkali metal nitrate such as sodium nitrate, in a preferred amount from about 1 to about 10 mmol/l, and a most preferred amount from about 4 to about 7 mmol/l.

It is also preferred that the amount of chloride ions is as low as possible, preferably below about 0.5 mmoles/liter, most preferably below about 0.1 mmoles/liter, particularly below about 0.03 mmoles/liter. Too much chloride increases the risk for corrosion, but may also cause formation of chlorine when the composition is used for chlorine dioxide production. As chloride normally is present as an impurity in alkali metal chlorate, it is advisable to use chlorate without extra added chloride, normally containing less than about 0.5, suitably less than about 0.05, preferably less than about 0.02, most preferably less than about 0.01 wt % of alkali metal chloride calculated as NaCl in NaClO₃.

The composition may contain as impurities ions of chromium and iron, particularly Cr³⁺ and Fe²⁺. The presence of these ions increases the decomposition of the hydrogen peroxide, and it is desired to keep their content as low as possible. However, they are inevitably released during storage of the composition in steel containers and may also be introduced as impurities in the alkali metal chlorate. The content of Cr³⁺ is normally from about 0.5 to about 3 mg/l, particularly from about 1 to about 2 mg/l, while the content of Fe²⁺ normally is from about 0.05 to about 5 mg/l, particularly from about 1 to about 2 mg/l.

Any alkali metal chlorate can be used, such as sodium, potassium or mixtures thereof, although sodium chlorate is preferred.

Besides the main ingredients discussed above and any unavoidable impurities in the composition, it is preferred that the balance up to 100% is mainly made up of water.

The novel composition may be prepared by simply mixing the ingredients together, for example by dissolving solid alkali metal chlorate in water and adding aqueous solutions of hydrogen peroxide, and one or more polymeric stabilizer, optionally a protective colloid, a radical scavenger or a chelant and any other optional substance. Alternatively, solid alkali metal chlorate may be dissolved in an aqueous solution of hydrogen peroxide of suitable concentration and adding the other component(s) before or after the alkali metal chlorate.

A composition as described above is substantially storage stable and can be transported safely. It is also more pleasant to handle for the plant operators as the content of hydrogen peroxide is lower than in normal hydrogen peroxide of technical grade, which generally contains about 50 wt. % H₂O₂. The polymer stabilized hydrogen peroxide-chlorate solutions described herein may have stability at elevated temperature for extended time periods. In some embodiments, after 16 hours at 96° C. the hydrogen peroxide concentration of the aqueous hydrogen peroxide-chlorate solution is reduced by ≤about 5 weight %. In further embodiments, after 16 hours at 96° C. the hydrogen peroxide concentration of the aqueous hydrogen peroxide-chlorate solution is reduced by ≤about 3.5 weight %. In still further embodiments, the reduction in hydrogen peroxide concentration is measured in the presence of 0.2 ppm iron, 0.3 ppm aluminum, 0.1 ppm nickel, and/or 0.1 ppm chromium. In some embodiments, the foregoing decomposition results refer to solutions with a H₂O₂ concentration of about 35 weight %. Changes in stability may accompany changes in polymeric stabilizer concentration, with higher concentrations providing increased stability.

In the process for producing chlorine dioxide of the invention, a composition as described above and a mineral acid, preferably sulfuric acid, are used to feed materials. It has been found that when the composition of the invention is used as a feed, it is possible to avoid feeding an unnecessary excess of water and thus obtaining a more concentrated reaction mixture and higher production. It has also been found that the consumption of the mineral acid is lower than if alkali metal chlorate and hydrogen peroxide are fed separately, even if they are premixed before entering the reactor.

In the case sulfuric add is used as a feed, it preferably has a concentration from about 70 to about 96 wt %, most preferably from about 75 to about 85 wt % and preferably a temperature from about 0 to about 100° C. most preferably from about 20 to about 50° C., as it then may be possible to operate the process adiabatically. Preferably from about 2 to about 5 kg H₂SO₄, most preferably from about 3 to about 6 kg H₂SO₄ is fed per kg produced. Alternatively, the equivalent amount of another mineral acid may be used.

A preferred process of the invention comprises the steps of

(a) feeding a composition as described above and a mineral acid, or a mixture thereof, at one end of a tubular reactor to form a reaction mixture;
(b) reducing chlorate ions in the reaction mixture in said tubular reactor to form chlorine dioxide, wherein the degree of chlorate conversion to chlorine dioxide in said reactor suitably is from about 75% to 100%, preferably from about 80 to 100%, most preferably from about 95 to 100%; and
(c) recovering a product containing chlorine dioxide at the other end of said tubular reactor.

The product recovered is normally an aqueous solution containing chlorine dioxide, oxygen and an alkali metal salt of the mineral acid. It may also contain unreacted chemicals such as mineral acid and small amounts of chlorate ions. However, it has been found possible to avoid any substantial formation of chlorine.

It is preferred to operate without recirculating unreacted chemicals such as chlorate or sulfuric acid from the product back to the reactor. In some applications, the complete product mixture can be used without separation, for example in water purification.

It is normally favorable to operate the reactor as a CFSTR (constant flow stirred tank reactor). The reaction mixture in the bulk of the reactor preferably contains from 0 to about 2, most preferably from 0 to about 0.1 mol/l of chlorate ions, and from about 3 to about 10, most preferably from about 4 to about 6 mol/l of sulfuric acid. It is preferred to maintain the concentration of chlorate and sulfate below saturation to avoid crystallization of metal salts thereof.

Suitably the pressure in the reactor is from about 17 to about 120 kPa, preferably from about 47 to about 101 kPa, most preferably from about 67 to about 87 kPa. Although normally not necessary, it is possible also to supply extra inert gas such as air. The temperature is preferably maintained from about 30° C. to the boiling point of the reaction mixture, most preferably below the boiling point.

It is preferred that the composition of the invention is substantially uniformly dispersed in the mineral acid at the inlet of the reactor to avoid any substantial radial concentration gradients over the cross section of the reactor. In order to minimize the radial concentration gradients it has been found favorable to use a tubular reactor with an inner diameter from about 25 to about 250 mm, preferably from about 70 to about 130 mm.

The process of the invention is particularly suitable for production of chlorine dioxide in small scale, for example from about 0.1 to about 100 kg/h, preferably from about 0.1 to about 50 kg/h in one reactor. For many applications, a suitable chlorine dioxide production rate is from about 0.1 to about 10 kg/h, preferably from about 0.2 to about 7 kg/h, most preferably from about 0.5 to about 5 kg/h in one reactor. It is possible to achieve a high degree of chlorate conversion in a comparatively short reactor, preferably having a length from about 50 to about 500 mm, most preferably from about 100 to about 400 mm. It is particularly favorable to use a tubular reactor having a preferred ratio of the length to the inner diameter from about 12:1 to about 1:1, most preferably from about 4:1 to about 1.5:1. A suitable average residence time in the reactor is from about 1 to about 100 minutes, preferably from about 4 to about 40 minutes.

A small scale production unit normally consist of only one reactor, but it is possible to arrange several, for example up to about 15 or more reactors in parallel, for example as a bundle of tubes.

### Prophetic Example 1

A process of the invention is run by continuously feeding 78 wt % H₂SO₄ and a composition according to the invention to a tubular reactor having an internal diameter of 100 mm and a length of 300 mm. The composition of the invention is an aqueous solution of 40 wt % NaClO₃, 10 wt H₂O₂, and containing a polymeric stabilizer. The reactor is operated at a pressure of 500 mm Hg (67 kPa), a temperature of 40° C. and produces 5 lb (2.3 kg) ClO₂ per hr. As a comparison, a process may be run in the same way, with the exception that instead of feeding a composition according to the invention, aqueous solutions of 40 wt % NaClO₃ and of 50 wt % H₂O₂ are fed separately.

### Prophetic Example 2

A composition according to the invention is prepared by providing an aqueous solution of 40 wt % NaClO₃, about 10 wt % H₂O₂, and a polymeric stabilizer. The pH is adjusted by adding Na₄P₂O₇. The prepared solutions may contain as impurities 2 mg/l Fe²⁺ and 2 mg/l Cr³⁺. Samples of the solutions may be stored in vessels of steel (SS 2343) at 55° C., and the decomposition degree of the hydrogen peroxide measured after 14 days. For comparative purposes, compositions without polymeric stabilizer may be stored in the same way.

### Stability Testing

The stability of hydrogen peroxide solutions is very important for their safe storage and use. The stability can be measured by heating a sample and measuring the peroxide remaining. This test is conducted for 16 hours at 96° C. Mixtures of peroxides with other ingredients especially decomposition catalysts such as Fe, Cu, Mn, Pt, Os, Ag, Al, V, Ni, Cr will decrease the stability of hydrogen peroxide solutions.

### Procedure

### 1. Flask Preparation

1.1 Fill the flasks with 10% NaOH.
1.2 Heat the flasks at 96° C. for 60 minutes in a heating bath.
1.3 Remove the flasks from the heating bath and let them cool to room temperature.
1.4 Rinse the flasks with DIW (deionized water).
1.5 Fill the flasks with 10% HNO₃ for three hours.
1.6 Rinse the flasks thoroughly with Ultrapure water (three times).
1.7 Cover the flasks with aluminum foil.
1.8 Dry the flasks in a oven at 105° C. for one hour.
1.9 Remove the flasks from the oven and place them in a desiccator to cool to room temperature.

This cleaning must be done before each usage of the flasks. It is recommended that these flasks be dedicated to this procedure.

### 2. Stability Test

2.1 Analyze the sample for initial concentration of H₂O₂, by using an appropriate test method depending on whether analyzing pure solutions of H₂O₂, or the sample contains organic ingredients like surfactants, fragrances, flavors, etc.
2.2 Place 50 ml of the hydrogen peroxide being tested in a 100 ml volumetric flask prepared as at section 1. Cover the flask with a condenser cap or a centrifuge tube as an alternative.
2.3 Place the covered flasks in a 96° C. (205° F.) silicone oil or glycerin bath for 16 hours. Use an appropriate way to measure the temperature during the length of test, such as a thermocouple attached to a recorder. The flask should be immersed so that the liquid level is not above the 100 ml mark. Clamps should be used to suspend the flask in the bath or lead “donuts” should be used to prevent the flasks from overturning.
2.4 After 16 hours remove the flask from the bath and let it cool to room temperature.
2.5 Mix thoroughly the solution in the flask.
2.6 Analyze again the solution for H₂O₂ concentration using the same method as in section 2.1.

Note: For accurate results, the stability test should be conducted in duplicate.

### Calculations

Decomposition[%]=(Cᵢₙᵢₜᵢₐₗ−C_{final})/Cᵢₙᵢₜᵢₐₗ×100, where Cᵢₙᵢₜᵢₐₗ=initial concentration of H₂O₂, C_{final}=concentration of H₂O₂ after heating.

In general, H₂O₂ solutions which record hot stability values of over 96.5%, (decomposition less than 3.5%), will exhibit satisfactory shelf stability for at least a 12 month period under room temperature storage.

### Stability Results

Tables 1 to 4 show the % hydrogen peroxide decomposition from stability testing for aqueous hydrogen peroxide solutions containing various stabilizers and/or additives. A 50 wt % hydrogen peroxide solution containing 15 ppm nitric acid was used for the experiments of table 1. Two different 50 wt % hydrogen peroxide solutions containing 15 ppm phosphoric acid and having a reduced content of organic impurities were used for the experiments of tables 2 and 3. A 49.4 wt % hydrogen peroxide solution purified by reverse osmosis was used for the experiments of table 4. In tests conducted with a metal spike, a cocktail of metals was added corresponding to the following amounts in the hydrogen peroxide solution: 0.2 ppm iron, 0.3 ppm aluminum, 0.1 ppm chromium, and 0 ppm or 0.1 ppm nickel was added prior to the start of the stability test. Aluminum was added as a solution of 1 mg/ml of Al in 0.5N HNO₃. Chromium was added as a chromium (III) solution of 1 mg/ml of Cr in 2% HCl. Iron was added as a solution of 1 mg/ml of Fe in 2-5% HNO₃.

Tables 1 to 4 include the following abbreviations.

| | |
|---|---|
| NaHPP | Sodium hydrogen pyrophosphate |
| NaSN | Sodium stannate |
| A1000 | Acumer ™ 1000 (Dow): a polyacrylic acid with sodium hydrogen sulfite |
| | giving a pH of 3.2-4.0 and having a molecular weight of 4100-4900 g/mol. |
| A445 | ACUSOLTM 445 (Rohm and Haas): a partially neutralized homopolymer |
| | of acrylic acid giving a pH of 3.7 and having Mw of 4500 g/mol. |
| A445N | ACUSOL ™ 445N (Rohm and Haas): a neutralized homopolymer of acrylic |
| | acid giving a pH of 6.9 and having Mw of 4500 g/mol. |
| K-781 | CarbosperseTM K-781 Acrylate Terpolymer (Lubrizol): a partially |
| | neutralized acrylic terpolymer of acrylic acid, 2-acrylamido- |
| | 2-methylpropane sulfonic acid and sulfonated styrene giving a pH of 2.2-3.2 |
| | and having a molecular weight less than 10,000 g/mol. |
| A4161 | Acumer ™ 4161 (Rohm and Haas): a phosphinopolycarboxylic acid giving a |
| | pH of 3.0-3.5 and having a molecular weight of 3300-3900 g/mol measured |
| | by GPC of the acid form. |
| P9110 | Dequest ® P9110 (Italmatch): a phosphinopolycarboxylic acid giving a pH |
| | of 3.5-5 and having Mw of 4500-5500 g/mol. |
| P9500 | Dequest ® P9500 (Italmatch): a partially neutralized terpolymer of acrylic |
| | acid, 2-acrylamido-2-methylpropanesulfonic acid and sodium phosphinite |
| | giving a pH of 1.5-3.0. |
| X | Metal spike providing 0.1 ppm Nickel |
| XX | Metal spike providing no Nickel |

TABLE 1

| Stabilizer added | | | | | | |
|---|---|---|---|---|---|---|
| NaHPP | NaSN | A1000 | DTPMP | ATMP | Metal | Decomposition |
| (ppm) | (ppm) | (ppm) | (ppm) | (ppm) | Spike | result |
| 2.5 | 5 | 0 | 0 | 0 | | 0.45% |
| 2.5 | 5 | 2.5 | 0 | 0 | | 0.77% |
| 2.5 | 5 | 2.5 | 2.5 | 0 | | 1.02% |
| 2.5 | 5 | 2.5 | 0 | 2.5 | | 1.08% |
| 2.5 | 5 | 0 | 0 | 0 | X | 9.30% |
| 2.5 | 5 | 2.5 | 0 | 0 | X | 31.40% |
| 2.5 | 5 | 2.5 | 2.5 | 0 | X | 9.20% |
| 2.5 | 5 | 5 | 2.5 | 0 | X | 7.20% |

TABLE 2

| Stabilizer added | | | | | | | | |
|---|---|---|---|---|---|---|---|---|
| NaHPP | NaSN | A1000 | A445 | DTPMP | ATMP | K-781 | Metal | Decomposition |
| (ppm) | (ppm) | (ppm) | (ppm) | (ppm) | (ppm) | (ppm) | Spike | result |
| 2.5 | 5 | 0 | | 0 | 0 | 0 | | 1.61% |
| 2.5 | 5 | 2.5 | | 0 | 0 | 0 | | 2.54% |
| 2.5 | 5 | 2.5 | | 2.5 | 0 | 0 | | 0.85% |
| 2.5 | 2.5 | 2.5 | | 0 | 2.5 | 0 | | 1.97% |
| 2.5 | 2.5 | 0 | | 0 | 0 | 10 | | 0.91% |
| 2.5 | 5 | 0 | | 0 | 0 | 0 | X | 3.90% |
| 2.5 | 5 | 2.5 | | 2.5 | 0 | 0 | X | 5.40% |
| 2.5 | 5 | 5 | | 2.5 | 0 | 0 | X | 5.60% |
| 2.5 | 5 | 2.5 | | 5 | 0 | 0 | X | 7.60% |
| 2.5 | 5 | 0 | | 5 | 0 | 0 | XX | 7.06% |
| 2.5 | 5 | 0 | | 10 | 0 | 0 | XX | 1.67% |
| 2.5 | 5 | 5 | | 5 | 0 | 0 | XX | 2.96% |
| 2.5 | 5 | 5 | | 2.5 | 0 | 0 | XX | 5.60% |
| 2.5 | 5 | 0 | 5 | 5 | 0 | 0 | XX | 2.70% |
| 2.5 | 5 | 0 | 10 | 0 | 0 | 0 | XX | 5.10% |

TABLE 3

| Stabilizer added | | | | | |
|---|---|---|---|---|---|
| NaHPP | NaSN | A445N | A4161 | | Decomposition |
| (ppm) | (ppm) | (ppm) | (ppm) | Metal Spike | result |
| 2.5 | 5 | 50 | 0 | X | 3.62% |
| 2.5 | 5 | 25 | 0 | X | 4.16% |
| 2.5 | 5 | 12.5 | 0 | X | 4.42% |
| 2.5 | 5 | 0 | 50 | X | 2.88% |
| 2.5 | 5 | 0 | 25 | X | 1.88% |
| 2.5 | 5 | 0 | 12.5 | X | 1.88% |

TABLE 4

| Stabilizer added | | | | | | |
|---|---|---|---|---|---|---|
| NaHPP | NaSN | A4161 | P9110 | P9500 | K-781 | Decomposition |
| (ppm) | (ppm) | (ppm) | (ppm) | (ppm) | (ppm) | result |
| 0 | 0 | 0 | 0 | 0 | 0 | 57.3% |
| 0 | 0 | 10 | 0 | 0 | 0 | 1.4% |
| 0 | 0 | 20 | 0 | 0 | 0 | 1.3% |
| 0 | 0 | 100 | 0 | 0 | 0 | 0.5% |
| 0 | 0 | 200 | 0 | 0 | 0 | 1.1% |
| 0 | 0 | 0 | 20 | 0 | 0 | 1.7% |
| 0 | 0 | 0 | 0 | 20 | 0 | 1.8% |
| 0 | 0 | 0 | 0 | 0 | 100 | 0.8% |

It is understood that the foregoing detailed description and accompanying examples are merely illustrative and are not to be taken as limitations upon the scope of the invention, which is defined solely by the appended claims and their equivalents. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

For reasons of completeness, various aspects of the invention are set out in the following numbered clauses:

Clause 1. An aqueous composition comprising hydrogen peroxide;
an alkali metal chlorate; and
one or more polymeric stabilizers selected from
a) a phosphino polycarboxylic acid, or salt thereof, the phosphino polycarboxylic acid having a molecular weight of 1500 to 10,000 g/mol;
b) a poly(acrylic acid), or a salt thereof, with molecular weight of 4000-5000 g/mol; and
c) a polymer, or salt thereof, with molecular weight of 3000 to 15,000 g/mol, the polymer being derived from a plurality of monomer units of each of

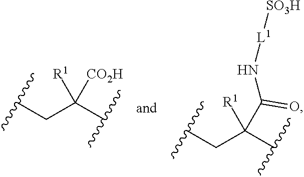

and optionally

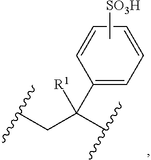

wherein R¹ is hydrogen or C₁₋₄alkyl and L¹ is C₂₋₆alkylene.
Clause 2. The composition of clause 1, wherein the one or more polymeric stabilizers is selected from the phosphino polycarboxylic acid, or salt thereof.
Clause 3. The composition of clause 2, wherein the phosphino polycarboxylic acid has formula (I):

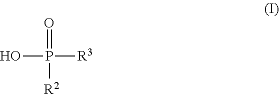

wherein
R² is

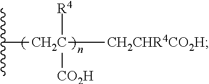

R³ is

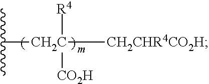

R⁴, at each occurrence, is independently hydrogen or C₁₋₄alkyl; and
m and n are each independently an integer, where m+n is an integer from 30 to 60.
   Clause 4. The composition of clause 3, wherein R⁴ is hydrogen.
   Clause 5. The composition of any of clauses 1-4, wherein the phosphino polycarboxylic acid has a molecular weight of 3300-3900 g/mol.
   Clause 6. The composition of clause 1, wherein the one or more polymeric stabilizers is selected from the poly(acrylic acid), or a salt thereof.
   Clause 7. The composition of clause 6, wherein the poly(acrylic acid), or salt thereof, has a molecular weight of 4100-4900 g/mol.
   Clause 8. The composition of clause 1, wherein the one or more polymeric stabilizers is selected from a polymer, or salt thereof, with molecular weight of 3000 to 15,000 g/mol, the polymer being derived from a plurality of monomer units of each of

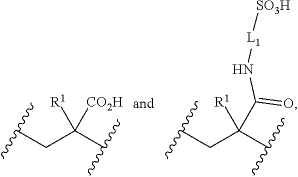

wherein R¹ is hydrogen or C₁₋₄alkyl and L¹ is C₂₋₆alkylene.
Clause 9. The composition of clause 8, wherein the polymer is derived from a plurality of monomer units of each of

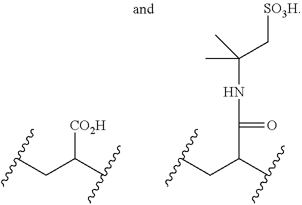

Clause 10. The composition of clause 1, wherein the one or more polymeric stabilizers is selected from a polymer, or salt thereof, with molecular weight of 3000 to 15,000 g/mol, the polymer being derived from a plurality of monomer units of each of

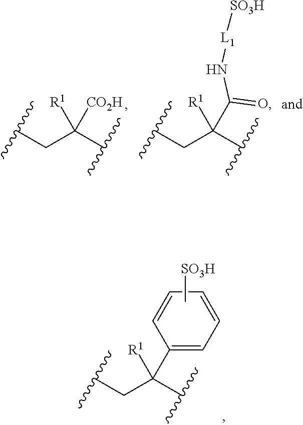

wherein R¹ is hydrogen or C₁₋₄alkyl and L¹ is C₂₋₆alkylene.
Clause 11. The composition of clause 10, wherein the polymer is derived from a plurality of monomer units of each of

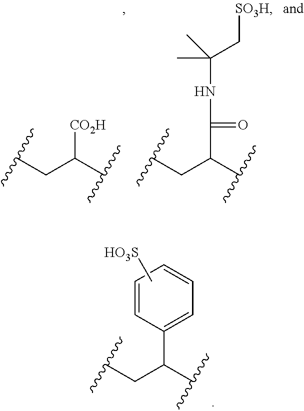

Clause 12. The composition of any one of clauses 1-11 comprising 0.1-1500 ppm of the one or more polymeric stabilizers.
Clause 13. The composition of any one of clauses 1-12 comprising from about 1 to about 6.5 mol/l of alkali metal chlorate and from about 1 to about 7 mol/l of hydrogen peroxide.
Clause 14. The composition of any one of clauses 1-13 further comprising one or more of a phosphate, a stannate, or a chelant.
Clause 15. The composition of clause 14, wherein the phosphate is one or more of phosphoric acid, pyrophosphoric acid, or metaphosphoric acid, or a salt thereof.
Clause 16. The composition of clauses 14 or 15, wherein the phosphate salt is an alkaline salt.
Clause 17. The composition of any one of clauses 1-16 having a pH of about 1 to about 4.
Clause 18. The composition of any one of clauses 1-17 comprising an alkali metal nitrate in a concentration of about 1 mM to about 10 mM.
Clause 19. The composition of any one of clauses 1-18, having a chloride ion content of less than 0.5 mM.
Clause 20. The composition of any one of clauses 1-19 comprising less than 5 ppm of a chelating substance other than the one or more polymeric stabilizers.
Clause 21. The composition of clause 20, wherein the composition is free of a chelating substance other than the one or more polymeric stabilizers.
Clause 22. A process for preparing chlorine dioxide comprising:
feeding the aqueous composition of any of clauses 1-21 to a reactor;
adding a mineral acid to react chlorate ions with hydrogen peroxide to form chlorine dioxide; and
recovering chloride dioxide.
Clause 23. The process of clause 22, wherein sulfuric acid is added and chlorate ions are reacted with hydrogen peroxide at a sulfuric acid concentration of from about 4 to about 6 mol/l.

1. An aqueous composition comprising
hydrogen peroxide;
an alkali metal chlorate; and
one or more polymeric stabilizers selected from
a) a phosphino polycarboxylic acid, or salt thereof, the phosphino polycarboxylic acid having a molecular weight of 1500 to 10,000 g/mol;
b) a poly(acrylic acid), or a salt thereof, with molecular weight of 4000-5000 g/mol; and
c) a polymer, or salt thereof, with molecular weight of 3000 to 15,000 g/mol, the polymer being derived from a plurality of monomer units of each of 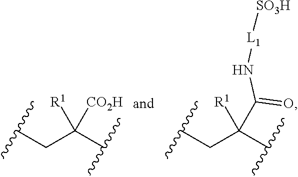
and optionally 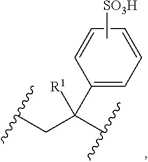
wherein R¹ is hydrogen or C₁₋₄alkyl and L¹ is C₂₋₆alkylene.

2. The composition of claim 1, wherein the one or more polymeric stabilizers is selected from the phosphino polycarboxylic acid, or salt thereof.

3. The composition of claim 2, wherein the phosphino polycarboxylic acid has formula (I): 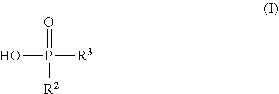
wherein
R² is 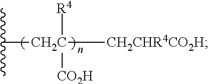
R³ is 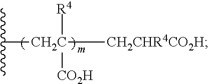
R⁴, at each occurrence, is independently hydrogen or C₁₋₄alkyl; and
m and n are each independently an integer, where m+n is an integer from 30 to 60.

4. The composition of claim 3, wherein R⁴ is hydrogen.

5. The composition of claim 1, wherein the phosphino polycarboxylic acid has a molecular weight of 3300-3900 g/mol.

6. The composition of claim 1, wherein the one or more polymeric stabilizers is selected from the poly(acrylic acid), or a salt thereof.

7. The composition of claim 6, wherein the poly(acrylic acid), or salt thereof, has a molecular weight of 4100-4900 g/mol.

8. The composition of claim 1, wherein the one or more polymeric stabilizers is selected from a polymer, or salt thereof, with molecular weight of 3000 to 15,000 g/mol, the polymer being derived from a plurality of monomer units of each of 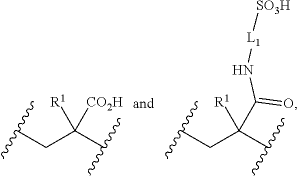
wherein R¹ is hydrogen or C₁₋₄alkyl and L¹ is C₂₋₆alkylene.

9. The composition of claim 8, wherein the polymer is derived from a plurality of monomer units of each of

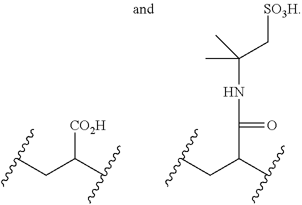

10. The composition of claim 1, wherein the one or more polymeric stabilizers is selected from a polymer, or salt thereof, with molecular weight of 3000 to 15,000 g/mol, the polymer being derived from a plurality of monomer units of each of 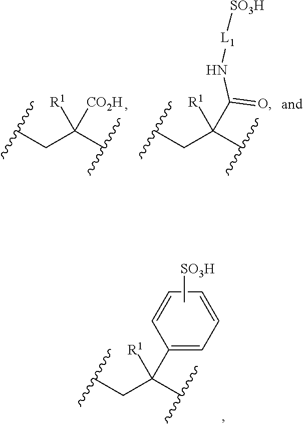
wherein R¹ is hydrogen or C₁₋₄alkyl and L¹ is C₂₋₆alkylene.

11. The composition of claim 10, wherein the polymer is derived from a plurality of monomer units of each of

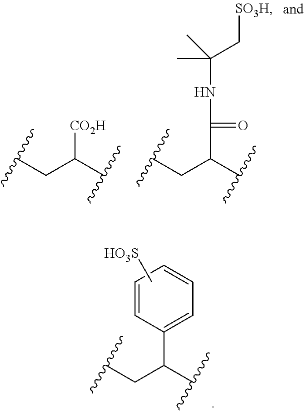

12. The composition of claim 1 comprising 0.1-1500 ppm of the one or more polymeric stabilizers.

13. The composition of claim 1 comprising from about 1 to about 6.5 mol/l of alkali metal chlorate and from about 1 to about 7 mol/l of hydrogen peroxide.

14. The composition of claim 1 further comprising one or more of a phosphate, a stannate, or a chelant.

15. The composition of claim 14, wherein the phosphate is one or more of phosphoric acid, pyrophosphoric acid, or metaphosphoric acid, or a salt thereof.

16. The composition of claim 14, wherein the phosphate salt is an alkaline salt.

17. The composition of claim 1 having a pH of about 1 to about 4.

18. The composition of claim 1 comprising an alkali metal nitrate in a concentration of about 1 mM to about 10 mM.

19. The composition of claim 1, having a chloride ion content of less than 0.5 mM.

20. The composition of claim 1 comprising less than 5 ppm of a chelating substance other than the one or more polymeric stabilizers.

21. The composition of claim 20, wherein the composition is free of a chelating substance other than the one or more polymeric stabilizers.

22. A process for preparing chlorine dioxide comprising:
feeding the aqueous composition of any of claim 1 to a reactor;
adding a mineral acid to react chlorate ions with hydrogen peroxide to form chlorine dioxide; and
recovering chloride dioxide.

23. The process of claim 22, wherein sulfuric acid is added and chlorate ions are reacted with hydrogen peroxide at a sulfuric acid concentration of from about 4 to about 6 mol/l.
